(19) United States
(12) Patent Application Publication
(10) Pub. No.: US 2025/0285400 A1
(43) Pub. Date: Sep. 11, 2025

(54) LOCATION-AWARE TEXT SEARCH AND VISUALIZATION CAPABILITIES FOR PHYSICAL ENVIRONMENTS

(71) Applicant: Siemens Industry Software Inc., Plano, TX (US)

(72) Inventors: Vladislav Murashkin, Ann Arbor, MI (US); Rafael Blumenfeld, Raanana (IL)

(73) Assignee: Siemens Industry Software Inc., Plano, TX (US)

(21) Appl. No.: 18/859,088

(22) PCT Filed: May 13, 2022
(86) PCT No.: PCT/US2022/029131

§ 371 Date: Oct. 22, 2024

(51) Int. Cl. G06V 10/25; G06T 3/608; G06T 5/80; G06V 20/70; G06V 30/10

(52) U.S. Cl. CPC G06V 10/25; G06T 3/608; G06T 5/80; G06V 20/70; G06V 30/10

(57) ABSTRACT

A computing system may include an image access engine configured to access a panoramic point cloud image of a physical environment. The computing system may also include an environment location-aware text engine configured to transform the panoramic point cloud image into an alternate representation that reduces distortion in the panoramic point cloud image and perform an optical character recognition (OCR) process on the alternate representation to determine text in the panoramic point cloud image. The environment location-aware text engine may further be configured to construct text labels to track the text determined in the panoramic point cloud image and support text searches for the physical environment through the text labels.

### BACKGROUND

Computer systems can be used to create, use, and manage data for products, items, and other objects. Examples of computer systems include computer-aided design (CAD) systems (which may include computer-aided engineering (CAE) systems), visualization and manufacturing systems, product data management (PDM) systems, product lifecycle management (PLM) systems, and more. These systems may include components that facilitate the design, visualization, and simulated testing of product structures and product manufacture.

### BRIEF DESCRIPTION OF THE DRAWINGS

Certain examples are described in the following detailed description and in reference to the drawings.

FIG. 1 shows an example of a computing system that supports location-aware text capabilities for physical environments.

FIG. 2 shows an example transformation of a panoramic point cloud image into an alternate representation in support of location-aware text capabilities for physical environments.

FIG. 3 shows an example of text label construction through an environment location-aware text engine in support of location-aware text capabilities for physical environments.

FIG. 4 shows an example construction of an oriented view of a physical environment for a text search term via text labels constructed by the environment location-aware text engine.

FIG. 5 shows an example of logic that a system may implement to support location-aware text capabilities for physical environments.

FIG. 6 shows an example of a computing system that supports location-aware text capabilities for physical environments.

### DETAILED DESCRIPTION

With continuing advances in technology, digital representations of physical environments are increasingly possible. For example, 3-dimensional (3D) scanning cameras can create point clouds by determining a large number of points on surfaces of a physical environment. Such point cloud technologies can be used in increasingly complex analyses and designs of textile factories, automotive manufacturing lines, microcircuit fabrication centers, or any other industrial setting. Nearly all physical environments include text, whether as safety signs, logos, machinery instructions, or countless other forms of textual information.

Scans of physical environments (e.g., point clouds) may capture the textual information included in the physical environment as pixel or point data, but typically provide little or no further context as to the location or other textual information specific for the text in the physical environment. Nor do such scans recognize the actual text itself in the physical environment. Determining and annotating such textual information in a physical environment is often performed as a manual process. Textual information in a physical environment is not indexed in any searchable database, and simple text recognition processes fail to account for location of text within the physical environment.

The disclosure herein may provide systems, methods, devices, and logic for location-aware text capabilities for physical environments. As described in greater detail, the environment location-aware text technology of the present disclosure may allow for identification and tracking of text in physical environments in a manner by which location data (e.g., 3D coordinates) of identified text is tracked. The environment location-aware text technology of the present disclosure may allow for the construction of text labels to track identified text, doing so in a searchable manner to allow text-specific searches traced to specific locations in a physical environment. Through various visualization capabilities, locations of a physical environment in which searched text is present can be presented through oriented views, with high-contrast text overlay objects used to present text in a given virtual view of the physical environment with increased clarity and precision. As such, the environment location-aware text technology of the present disclosure may improve virtual navigation of physical environments, allowing for improved system capabilities and new functionality.

These and other features of the environment location-aware text technology and the technical benefits of the present disclosure are described in greater detail herein.

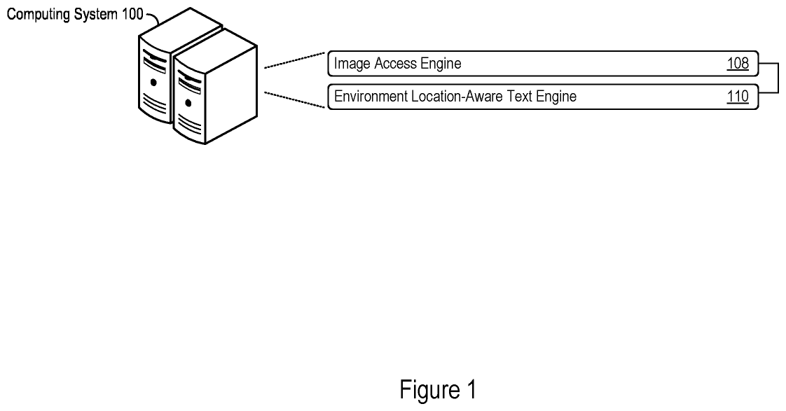

FIG. 1 shows an example of a computing system 100 that supports location-aware text capabilities for physical environments. The computing system 100 may take the form of a single or multiple computing devices such as application servers, compute nodes, desktop or laptop computers, smart phones or other mobile devices, tablet devices, embedded controllers, and more. In some implementations, the computing system 100 hosts, supports, executes, or implements an application that provides any combination of capabilities to visualize physical environments.

As an example implementation to support any combination of the environment location-aware text features described herein, the computing system 100 shown in FIG. 1 includes an image access engine 108 and an environment location-aware text engine 110. The computing system 100 may implement the engines 108 and 110 (including components thereof) in various ways, for example as hardware and programming. The programming for the engines 108 and 110 may take the form of processor-executable instructions stored on a non-transitory machine-readable storage medium and the hardware for the engines 108 and 110 may include a processor to execute those instructions. A processor may take the form of single processor or multi-processor systems, and in some examples, the computing system 100 implements multiple engines using the same computing system features or hardware components (e.g., a common processor or a common storage medium).

In operation, the image access engine 108 may access a panoramic point cloud image of a physical environment, and the panoramic point cloud image may comprise location data for points in the panoramic point cloud image. In operation, the environment location-aware text engine 110 may transform the panoramic point cloud image into an alternate representation that reduces distortion in the panoramic point cloud image, perform an optical character recognition (OCR) process on the alternate representation to determine text in the panoramic point cloud image, construct text labels to track the text determined in the panoramic point cloud image, and support text searches for the physical environment through the text labels.

These and other environment location-aware text features and technical benefits are described in greater detail next.

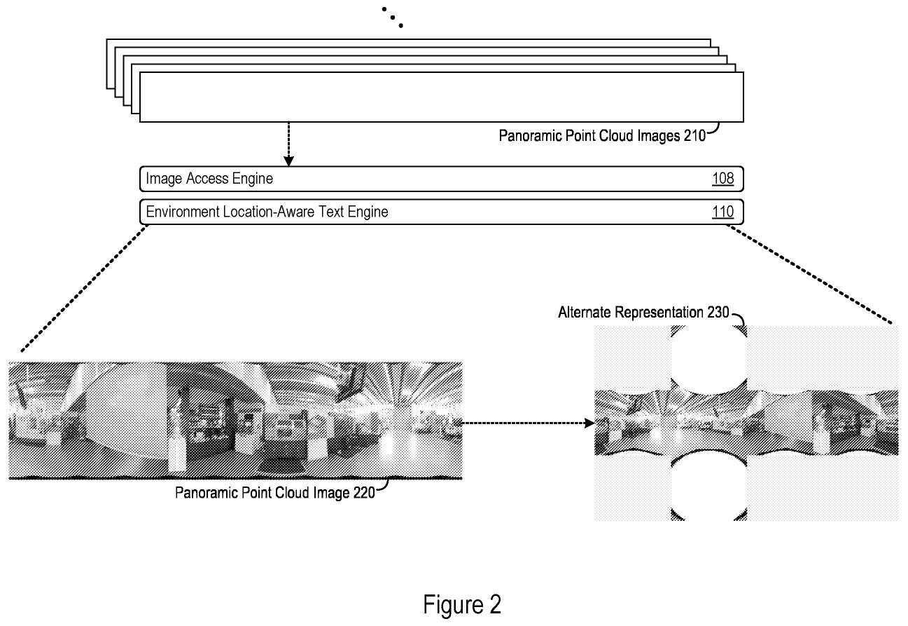

FIG. 2 shows an example transformation of a panoramic point cloud image into an alternate representation in support of location-aware text capabilities for physical environments. In the example of FIG. 2, the image access engine 108 accesses the panoramic point cloud images 210, which the image access engine 108 may do in any number of ways. The image access engine 108 may receive the panoramic point cloud images 210 via a network connection, e.g., from an imaging device that captured the panoramic point cloud images 210 or from an image processing system that constructed the panoramic point cloud images 210 from point cloud data for a given physical environment. As another example, the image access engine 108 may retrieve the panoramic point cloud images 210 from a configured network drive or via any additional or alterative ways.

The panoramic point cloud images 210 may take the form of any type of image generated for a physical environment through point cloud data. For instance, the panoramic point cloud images 210 may be captured by a 3D scanning device to capture a factory floor, and various point cloud images among the panoramic point cloud images 210 may depict different portions of the factory floor. As another illustrative example, the panoramic point cloud images 210 may be generated via laser scans of a facility, which may be regularly performed to track or monitor a physical environment.

The panoramic point cloud images 210 accessed by the image access engine 108 may be point cloud images in that the images may be comprised of, correlated to, associated with, of constructed from a point cloud, e.g., set of data points in a space (e.g., a 3D coordinate system). The panoramic point cloud images 210 may be logically distinct from the point clouds from which the panoramic point cloud images 210 are generated, though the environment location-aware technology of the present disclosure may leverage point cloud data to increase the textual recognition, search, and visualization capabilities for physical environments. For example, the point clouds from which the panoramic point cloud images 210 are generated may track, represent, comprise, or otherwise include location data with respect to a physical environment, such as through 3D coordinates. 3D scanning or photogrammetry programs can measure such points on the surface of a physical environment, assign coordinates in a 3D space, and utilize the point cloud data in order to generate the panoramic point cloud images 210. As such, discrete location data may be determined for portions (e.g., pixels) in the panoramic point cloud images 210 through the point clouds from which the panoramic point cloud images 210 are generated.

In some implementations, the panoramic point cloud images 210 may be generated by capturing images in combination with (e.g., in sync with) performing a point cloud scan. Construction of the panoramic point cloud images may then be performed by coloring the point cloud pixels based on the captured image color at the particular point cloud location. Thus, pixels in panoramic point cloud images may be directly correlated to point cloud pixels, and such point cloud pixels may provide location data (e.g., 3D coordinates) for pixels of the panoramic point cloud images 210. Panoramic point cloud images 210 may thus refer to and include panoramic images of physical environments in which pixels of a panoramic point cloud image are associated with corresponding point cloud data. As such, individual pixels in a given panoramic point cloud image may be mapped to corresponding locations in the physical environment, e.g., through 3D coordinates of a 3D space that maps the physical environment.

The panoramic point cloud images 210 may be panoramic in that the images can represent a specific view or viewing area in the physical environment, which may result from a fixed position in a physical environment at which an omnidirectional 3D scanning device captures point data for a given panoramic point cloud image. In that regard, a panoramic point cloud image may represent an “unwrapped” 360° view of a physical environment in a 2D, rectangular image format. Put another way, panoramic point cloud images may provide a 360° field of view angle along a horizontal direction from a given point in a physical environment. Thus, the panoramic point cloud images 210 accessed by the image access engine 108 may be equirectangular, in that a spherical view (e.g., a point cloud captured through a 360° field of view of a laser scanning device) is projected unto a rectangular image.

Though many physical environments may include text (e.g., signs, equipment or station identifiers, safety warnings, etc.), panoramic point cloud images generated via laser scans or other imaging technologies may lack any sort of data that identifies such text aside from image pixels or point data at the location of such text. The environment location-aware text engine 110 may support identification and tracking of text included in a physical environment by processing the panoramic point cloud images 210. However, equirectangular images may provide a distorted view of portions of a physical environment since a projection of a spherical view until a rectangular image format can result in stretching, line distortions, skewing, or other visual effects that affect the accuracy at which text and objects in the physical environment are represented.

To address such image distortions, the environment location-aware text engine 110 may transform the panoramic point cloud images 210 into an alternate representation that reduces distortion. In the example of FIG. 2, the environment location-aware text engine 110 transforms a panoramic point cloud image 220 into an alternate representation 230, doing so to reduce (e.g., eliminate) distortions caused by equirectangular projections in the panoramic point cloud image 220. As used herein, a reduction in distortion may refer to or include any transformation to a different image format that increases the effectiveness of text recognition via OCR processes. As such, image transformations by the environment location-aware text engine 110 for distortion reduction may include image sharpening processes or transformations into different image formats that reduce skew or stretching, otherwise eliminate visual artifacts that reduce text clarity in panoramic point cloud images.

As illustrative examples, the environment location-aware text engine 110 may transform the panoramic point cloud images into cube maps, cylindrical, Mercator, sinusoidal, or any other suitable image format. In the particular example shown in FIG. 2, the alternate representation 230 to which the environment location-aware text engine 110 transforms the panoramic point cloud image 220 is a cube map. However, any other suitable image format that the alternate representation may take is contemplated herein. The environment location-aware text engine 110 may thus implement any image transformation capabilities in order to process panoramic point cloud images for distortion reductions, improved text clarity, and the like.

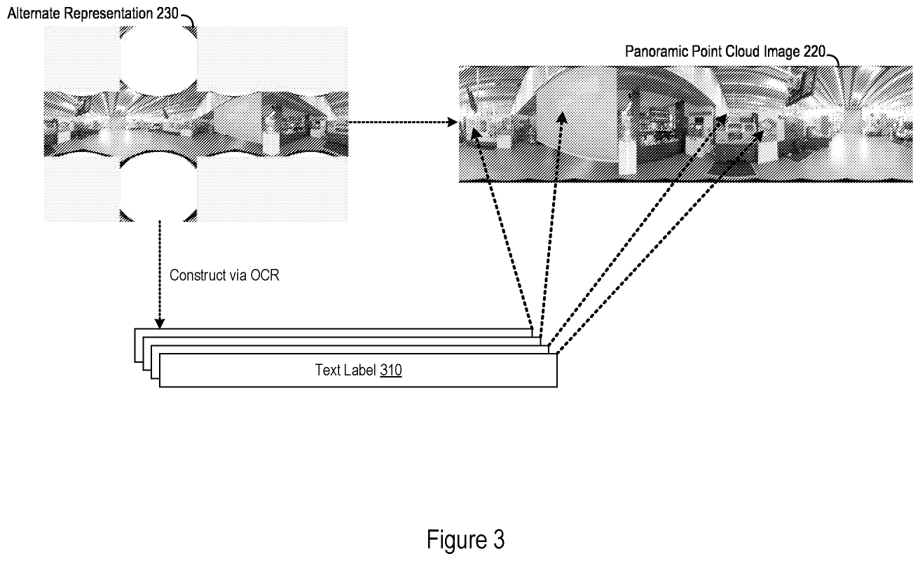

Through the alternate representations transformed from panoramic point cloud images, the environment location-aware text engine 110 may identify text in physical environments and construct text labels to track identified text. Examples of such features are described in greater detail next with reference to FIG. 3.

FIG. 3 shows an example of text label construction through the environment location-aware text engine 110 in support of location-aware text capabilities for physical environments. In the example of FIG. 3, the environment location-aware text engine 110 processes an alternate representation 230 of a panoramic point cloud image 220 to identify text in a physical environment depicted by the panoramic point cloud image 220. To do so, the environment location-aware text engine 110 may perform an OCR process on the alternate representation 230 to determine text in the panoramic point cloud image 220, doing so via any suitable OCR technique, process, or algorithm.

In some implementations, OCR processes applied by the environment location-aware text engine 110 may output a bounding box around identified text in the alternate representation 230. Each instance of text identified in the alternate representation 230 may be tracked by the environment location-aware text engine 110 through a respective bounding box. However, as the environment location-aware text engine 110 may perform the OCR process on the alternate representation 230 (and not the panoramic point cloud image 220 itself), the pixels of the alternate representation 230 at which bounding boxes are identified may lack location data for the physical environment in which such text occurs.

To correlate the identified text and bounding boxes in the alternate representation 230, the environment location-aware text engine 110 may map text identified in the alternate representation 230 to corresponding locations in the panoramic point cloud image 220. To do so, the environment location-aware text engine 110 may transform the alternate representation 230 back into the panoramic point cloud image 220 or otherwise access the panoramic point cloud image 220 from which the alternate representation 230 was generated. In transforming panoramic point cloud images to alternate representations, the environment location-aware text engine 110 may maintain a 1:1 pixel correlation between the images. As such, the environment location-aware text engine 110 may map an individual pixel in the alternate representation 230 to a corresponding individual pixel in the panoramic point cloud image 220, and vice versa.

Through such a pixel correlation, the environment location-aware text engine 110 may determine, assign, or otherwise designate corresponding locations in the panoramic point cloud image 220 at which text identified in the alternate representation 230 is located. In doing so, the environment location-aware text engine 110 may assign 3D coordinates to text identified in the physical environment. In some implementations, the environment location-aware text engine 110 may correlate identified text via selected points of bounding boxes of text identified in the alternate representation 230. To provide an illustrative example, the environment location-aware text engine 110 may determine a bounding box for a given instance of text identified in the alternate representation 230. The environment location-aware text engine 110 may identify selected points in this bounding box in the alternate representation 230, such as corner coordinates or a center coordinate of the bounding box, and identify the corresponding coordinates of these selected points in the panoramic point cloud image 220. Through these corresponding coordinates in the panoramic point cloud image 220, the environment location-aware text engine 110 may construct a bounding box for the given instance of text in the panoramic point cloud image 220, even though the given instance of text was identified in the alternate representation 230.

Beyond mere text identification, the environment location-aware text technology of the present disclosure may provide capabilities to combine location data with text identified in a physical environment, which may support location-aware text capabilities in analyzing the physical environment. In support of such features, the environment location-aware text engine 110 may leverage location data embedded or otherwise included as part of point cloud data of panoramic point cloud images. As the environment location-aware text engine 110 can determine specific pixels in the panoramic point cloud image 220 at which text is identified (e.g., through selected boundary box points), the environment location-aware text engine 110 can extract the location data for these specific pixels, e.g., 3D coordinate data of the data points in the point cloud at these specific pixels in the panoramic point cloud image 220. Such location data (e.g., 3D coordinates) may be directly embedded within, associated with, or otherwise correlated to these specific pixels through the point cloud construction of the panoramic point cloud image 220 (or by accessing the corresponding point cloud from which the panoramic point cloud image 220 was constructed from). As such, the environment location-aware text engine 110 may track locations of identified text in a physical environment, for example by assigning 3D coordinates to a given text label for the text tracked by the given text label.

The environment location-aware text engine 110 may construct text labels to track text identified in a physical environment via the alternate representation 230 and mapped to the panoramic point cloud image 220. A text label may refer to any data element that stores textual information for identified text in a physical environment, and the environment location-aware text engine 110 may construct text labels in any number of forms or formats. In the example of FIG. 3, the environment location-aware text engine 110 constructs the text labels 310 for text identified in the panoramic point cloud image 220 via an OCR process performed on the alternate representation 230.

The environment location-aware text engine 110 may construct the text labels 310 such that each instance of text identified in a physical environment is tracked via specific textual information. Example forms of textual information that the environment location-aware text engine 110 may track in text labels may include an ID of a particular panoramic point cloud image (e.g., among a set of panoramic point cloud images 210 that in combination depict a physical environment) that the instance of text is identified within, 3D coordinates (or any other form of location data) at which the instance of text is located (which may be specified via selected points of the instance of text or bounding box that surrounds the instance of text), the text itself that was identified (e.g., “Station #1” as the text itself determined via OCR), and the like.

In some implementations, the environment location-aware text engine 110 may construct the text labels 310 to include, for a given text section that includes a given text identified in the panoramic point cloud image 220, an identifier for the panoramic point cloud image 220, the location data for a selected point in the text section, and the given text included in the given text section. The given text section may include or otherwise be tracked through a bounding box for the given text in the panoramic point cloud image 220 and the location data in the text label may be for a selected point on or within the bounding box (e.g., bounding box corners or bounding box center).

As another example form of textual information to include in text labels, the environment location-aware text engine 110 may store visualization data to depict text in a virtual view of the physical environment in constructed text labels. Such visualization data may include spherical theta and phi angles for coordinates of selected locations in text sections in the panoramic point cloud image 220 that include the text, and such angles may represent respective vertical and horizontal angles that point from a sphere center in a 360° field of view to a specific point on a sphere at which the text occurs in a projection of the panoramic point cloud image 220 into the 360° field of view (e.g., in a wrapping of the panoramic point cloud image 220 unto a sphere for 360° viewing). Through such visualization data (e.g., spherical theta and phi angles), the environment location-aware text engine 110 may provide or support oriented views of the physical environment at which text occurs, as described in greater detail below.

The environment location-aware text engine 110 may store the constructed text labels 310 in a search-able database, through which queries can be performed to easily search and identify specific text located within a physical environment. Accordingly, through constructed text labels 310, the environment location-aware text engine 110 may support various location-aware text search and visualization capabilities for physical environments. The environment location-aware text engine 110 support queries for specific text in a physical environment, which may be specified via text search terms. For a given text search term, the environment location-aware text engine 110 may search among the text labels 310 for the specific text, and if found, can return 3D coordinates of any occurrence(s) of the text in the physical environment (e.g., via 3D coordinates of bounding box center), a listing any (e.g., all) panoramic point cloud images that contain the text, spherical theta and phi angles of selected points of the bounding box for such occurrences, or any additional or alternative textual information relevant to the determined occurrences.

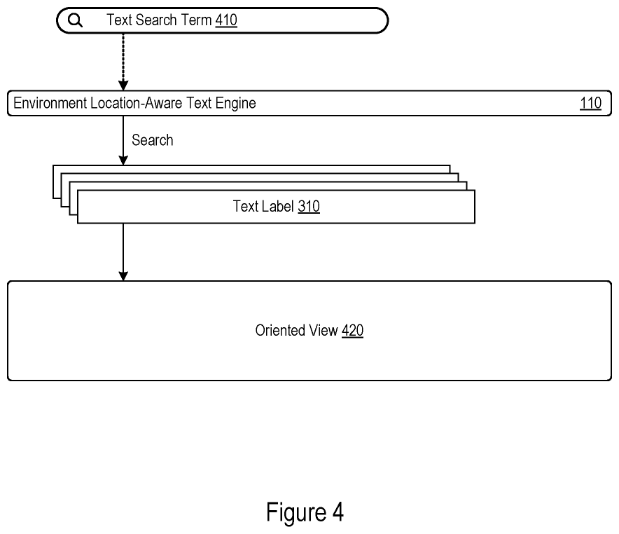

Through such text labels 310 and a searchable data structure that stores the text labels 310, the environment location-aware text engine 110 may present any search result “hits” for a given text search term in any number of ways. As an example, the environment location-aware text engine 110 may provide an oriented view of an occurrence of text in a physical environment that matches a text search term, example features of which are presented next with reference to FIG. 4.

FIG. 4 shows an example construction of an oriented view of a physical environment for a text search term via text labels constructed by the environment location-aware text engine 110. In the example of FIG. 4, the environment location-aware text engine 110 identifies (e.g., receives) a text search term 410 provided through a search query. The search query may be implemented via a user interface in which users can specify specific text search terms for which to look for in a physical environment captured through panoramic point cloud images. The environment location-aware text engine 110 may search among constructed text labels 310 for a physical environment using the text search term 410. As the text labels 310 may store textual information in the form of identified text in the physical environment, searching for specific text search terms may be possible through any suitable searching algorithm or technique, capabilities which the environment location-aware text engine 110 may implement or otherwise access.

Responsive to a determination that one more of the text labels 310 match the text search term 410, the environment location-aware text engine 110 may return search results for the text search term 410. Returning of search results may be provided by the environment location-aware text engine 110 in any number of ways, such as through providing a listing of search hits for the text search term 410, which may include providing any combination of the textual information stored in the text labels 310, such as panoramic point cloud image IDs, 3D coordinate data, thumbnail images of the text locations in the physical environment, etc.

In some instances, the environment location-aware text engine 110 may visualize a search result for the text search term 410 by providing an oriented view 420 of the physical environment that includes the text search term 410. The oriented view may be oriented (in a viewing angle) with respect to a location in the physical environment that comprises the text search term 410. To provide the oriented view 420, the environment location aware text engine 110 may utilize the spherical theta and phi angles stored for a specific text label that includes the text of the text search term 410. Through the spherical theta and phi angles (or any other relevant visualization data), the environment location-aware text engine 110 may project the view (e.g., in a rectangular format displayable through a monitor, screen, or user interface) of the physical environment specifically at a viewing point identified by the spherical theta and phi angles in a 360° view projected for a particular panoramic point cloud image identified by an panoramic point cloud image ID in the specific text label.

In such a manner, the oriented view 420 may provide a direct projection onto a location in the physical environment at which text specified in the text search term 420 occurs. The oriented view 420 may be specifically angled and presented along a specific line of sight such that the text occurrence in the physical environment is targeted. Doing so may provide increased visual clarity and reduced skew or distortion in a virtual navigation of the physical environment to the text occurrence.

While the oriented view 420 may be generated specific to the viewing angle of a particular occurrence of text, as dictated by a text search term 410, other text sections (aside from the text search term 410 may be present in the oriented view 420. The environment location-aware text engine 110 may de-skew these other text sections in the oriented view 420 that do not include the text search term 410. In some implementations, the location-aware text engine 110 may determine all text that is present in a given view of the physical environment (e.g., the oriented view 420 or any other presented view). To do so, the environment location-aware text engine may determine the coordinate boundaries of the given view and search the text labels 310 to determine any text that is included within the coordinate boundaries of the given view.

Then, the environment location-aware text engine 110 may de-skew text sections that include text present in the given view of the physical environment, and present the de-skewed text sections with the text present in the given view of the physical environment. De-skewing of text sections by the environment location-aware text engine 110 may include altering the bounding box of a text section (and, in some implementations, the text contents of the bounding box) such that the sides of the bounding box are parallel to the edges of the given view.

To de-skew or otherwise visualize text sections, the environment location-aware text engine 110 may generate text overlays. For text in a given view of a physical environment, the environment location-aware text engine 110 may generate a new visualization object that is overlaid on top of a particular view in a 360° viewing field or projected panoramic point cloud image, referred to herein as text overlay objects. A text overlay object may include a background color and the text included in the physical environment at the particular location. The environment location-aware text engine 110 may configure text overlay objects in various ones, such as by constructing the text overlay objects as a rectangle and determining background and text color based on contrast criteria (e.g., with color values that differ by a threshold amount, such as differing RGB values that exceed a difference threshold). One such example would be text overlay objects configured with a black background color and white text, or vice versa. Through support of generation and visualizing text overlay object in high-contrast modes, the environment location-aware text engine 110 may increase the readability of virtual views of a physical environment.

As another example, the environment location-aware text engine 110 may construct text overlay objects such that the background and/or text color are based on the physical environment itself, e.g., text color to match that of the text in the physical environment and/or the background color to match selected portions of the physical environment. As such, text overlay objects may be constructed to mimic physical surroundings and reduce changes in the virtual view that may be jarring to users viewing the physical environment, doing so while nonetheless providing accurate and readable text for the various text portions included in the virtual view of the physical environment.

Any suitable configurations for text overlay objects are contemplated herein, and such overlay object configurations may be customizable based on location within the physical environment (e.g., different rooms, for specific factory lines) or according to any other properties, context, or criteria whether specific to locations in the physical environment or any additional or alternative constraint. Through any of the ways described herein, the environment location-aware text engine 110 may visualize text in a given view of a physical environment through text overlay objects.

In visualizing text for a given (virtual) view of a physical environment, the environment location-aware text engine 110 may selectively determine which instances of text in the physical environment to visualize through text overlay objects and how the determined text overlay objects are visualized in the given view. In some implementations, the environment location-aware text engine 110 constructs and overlays the text overlay objects in the given virtual view as normal to the point of view depicted for the physical environment. Selective determination of which instances of text to overlay with text overlay objects may be based on an angle difference between the text instances in the physical environment and the point of view depicted in the given view (e.g., as specified through spherical theta and phi angles for the text instances and the current view). When the angle difference exceeds a configurable threshold (e.g., 20°), the environment location-aware text engine 110 may determine not to generate or visualize a text overlay object for that specific text instance. When the angle difference does not exceed a configurable threshold (e.g., 20°), the environment location-aware text engine 110 may construct the text overlay object to overlay in the given view for that specific text instance (e.g., doing so normal to the present view).

As yet another feature provided by the environment location-aware technology of the present disclosure, the environment location-aware engine 110 may construct text overlay objects to redact, hide, or obscure text in a given view of a physical environment. For confidential, sensitive, high-priority or text identified according to any configurable redaction criteria for a physical environment, the environment location-aware engine 110 may generate an overlay text object that obscures the actual text in given virtual view of the physical environment. Such text overlay objects may be constructed as black boxes without any text so as to obscure and hide instances of text in the physical environment that satisfy the redaction criteria.

While many environment location-aware text features have been described herein through illustrative examples presented through various figures, the image access engine 108 or the environment location-aware text engine 110 may implement any combination of the environment location-aware text technology described herein.

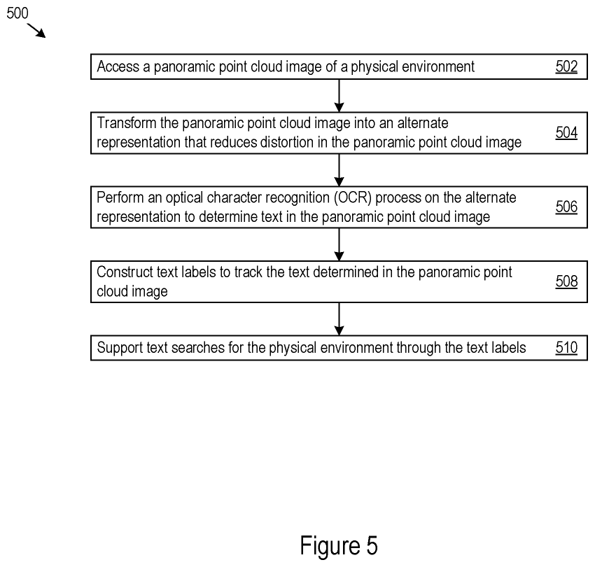

FIG. 5 shows an example of logic 500 that a system may implement to support location-aware text capabilities for physical environments. For example, the computing system 100 may implement the logic 500 as hardware, executable instructions stored on a machine-readable medium, or as a combination of both. The computing system 100 may implement the logic 500 via the image access engine 108 and the environment location-aware text engine 110, through which the computing system 100 may perform or execute the logic 500 as a method to provide any combination of the environment location-aware text features presented herein. The following description of the logic 500 is provided using the image access engine 108 and the environment location-aware text engine 110 as examples. However, various other implementation options by computing systems are possible.

In implementing the logic 500, the image access engine 108 may access a panoramic point cloud image of a physical environment (502), and the panoramic point cloud image may comprise location data for points in the panoramic point cloud image. In implementing the logic 500, the environment location-aware text engine 110 may transform the panoramic point cloud image into an alternate representation that reduces distortion in the panoramic point cloud image (504), perform an OCR process on the alternate representation to determine text in the panoramic point cloud image (506), construct text labels to track the text determined in the panoramic point cloud image (508), and support text searches for the physical environment through the text labels (510), doing so in any of the ways described herein.

The logic 500 shown in FIG. 5 provides an illustrative example by which a computing system 100 may support environment location-aware text capabilities according to the present disclosure. Additional or alternative steps in the logic 500 are contemplated herein, including according to any of the various features described herein for the image access engine 108, the environment location-aware text engine 110, or any combinations thereof.

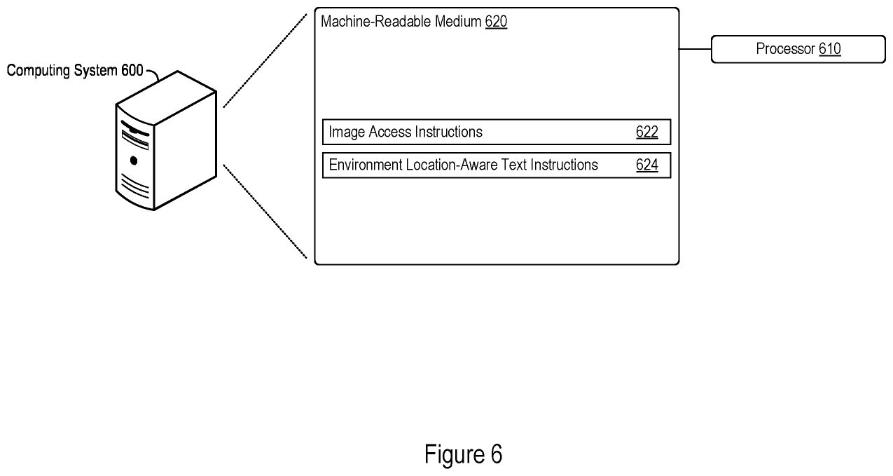

FIG. 6 shows an example of a computing system 600 that supports location-aware text capabilities for physical environments. The computing system 600 may include a processor 610, which may take the form of a single or multiple processors. The processor(s) 610 may include a central processing unit (CPU), microprocessor, or any hardware device suitable for executing instructions stored on a machine-readable medium. The computing system 600 may include a machine-readable medium 620. The machine-readable medium 620 may take the form of any non-transitory electronic, magnetic, optical, or other physical storage device that stores executable instructions, such as the image access instructions 622 and the environment location-aware text instructions 624 shown in FIG. 6. As such, the machine-readable medium 620 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 600 may execute instructions stored on the machine-readable medium 620 through the processor 610. Executing the instructions (e.g., the image access instructions 622 and/or the environment location-aware text instructions 624) may cause the computing system 600 to perform any aspect of the environment location-aware text technology described herein, including according to any of the features of the image access engine 108, the environment location-aware text engine 110, or combinations of both.

For example, execution of the image access instructions 622 by the processor 610 may cause the computing system 600 to access a panoramic point cloud image of a physical environment, and the panoramic point cloud image may comprise location data for points in the panoramic point cloud image. Execution of the environment location-aware text instructions 624 by the processor 610 may cause the computing system 600 to transform the panoramic point cloud image into an alternate representation that reduces distortion in the panoramic point cloud image, perform an OCR process on the alternate representation to determine text in the panoramic point cloud image, construct text labels to track the text determined in the panoramic point cloud image, and support text searches for the physical environment through the text labels.

Any additional or alternative environment location-aware text features as described herein may be implemented via the image access instructions 622, environment location-aware text instructions 624, or a combination of both.

The systems, methods, devices, and logic described above, including the image access engine 108 and the environment location-aware text engine 110, may be implemented in many different ways in many different combinations of hardware, logic, circuitry, and executable instructions stored on a machine-readable medium. For example, the image access engine 108, the environment location-aware text engine 110, or combinations thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the image access engine 108, the environment location-aware text engine 110, or combinations thereof.

The processing capability of the systems, devices, and engines described herein, including the image access engine 108 and the environment location-aware text engine 110, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
by a computing system:
accessing a panoramic point cloud image of a physical environment, wherein the panoramic point cloud image comprises location data for points in the panoramic point cloud image;
transforming the panoramic point cloud image into an alternate representation that reduces distortion in the panoramic point cloud image;
performing an optical character recognition (OCR) process on the alternate representation to determine text in the panoramic point cloud image;
constructing text labels to track the text determined in the panoramic point cloud image; and
supporting text searches for the physical environment through the text labels.

2. The method of claim 1, comprising constructing the text labels to include, for a given text section that includes a given text identified in the panoramic point cloud image:
an identifier for the panoramic point cloud image;
the location data for a selected point in the text section; and
the given text included in the given text section.

3. The method of claim 2, wherein the given text section comprises a bounding box for the given text in the panoramic point cloud image and the location data is for a selected point on or within the bounding box.

4. The method of claim 1, wherein the alternate representation comprises a cube map and wherein the text labels comprise spherical theta and phi angles for coordinates of selected locations in text sections in the panoramic point cloud image that include the text.

5. The method of claim 1, wherein supporting text searches for the physical environment through the text labels comprises:
identifying a text search term provided through a search query; and
providing an oriented view of the physical environment that comprises the text search term, wherein the oriented view comprises a virtual view of the physical environment oriented with respect to a location in the physical environment that comprises the text search term.

6. The method of claim 5, further comprising de-skewing other text sections in the oriented view that do not include the text search term.

7. The method of claim 1, wherein supporting text searches for the physical environment through the text labels comprises:
determining all text that is present in a given view of the physical environment;
de-skewing text sections that include the text present in the given view of the physical environment; and
presenting the de-skewed text sections with the text present in the given view of the physical environment.

8. A system comprising:
a processor; and
a non-transitory machine-readable medium comprising instructions that, when executed by the processor, cause a computing system to:
access a panoramic point cloud image of a physical environment, wherein the panoramic point cloud image comprises location data for points in the panoramic point cloud image; and
transform the panoramic point cloud image into an alternate representation that reduces distortion in the panoramic point cloud image;
perform an optical character recognition (OCR) process on the alternate representation to determine text in the panoramic point cloud image;
construct text labels to track the text determined in the panoramic point cloud image; and
support text searches for the physical environment through the text labels.

9. The system of claim 8, wherein the instructions, when executed, cause the computing system to construct the text labels to include, for a given text section that includes a given text identified in the panoramic point cloud image:
an identifier for the panoramic point cloud image;
the location data for a selected point in the text section; and
the given text included in the given text section.

10. The system of claim 9, wherein the given text section comprises a bounding box for the given text in the panoramic point cloud image and the location data is for a selected point on or within the bounding box.

11. The system of claim 8, wherein the alternate representation comprises a cube map and wherein the text labels comprise spherical theta and phi angles for coordinates of selected locations in text sections in the panoramic point cloud image that include the text.

12. The system of claim 8, wherein the instructions, when executed, cause the computing system to support text searches for the physical environment through the text labels by:
identifying a text search term provided through a search query; and
providing an oriented view of the physical environment that comprises the text search term, wherein the oriented view comprises a virtual view of the physical environment oriented with respect to a location in the physical environment that comprises the text search term.

13. The system of claim 12, wherein the instructions, when executed, further cause the computing system to de-skew other text sections in the oriented view that do not include the text search term.

14. The system of claim 8, wherein the instructions, when executed, cause the computing system to support text searches for the physical environment through the text labels by:
determining all text that is present in a given view of the physical environment:
de-skewing text sections that include the text present in the given view of the physical environment; and
presenting the de-skewed text sections with the text present in the given view of the physical environment.

15. A non-transitory machine-readable medium comprising instructions that, when executed by a processor, cause a computing system to:
access a panoramic point cloud image of a physical environment, wherein the panoramic point cloud image comprises location data for points in the panoramic point cloud image; and
transform the panoramic point cloud image into an alternate representation that reduces distortion in the panoramic point cloud image;
perform an optical character recognition (OCR) process on the alternate representation to determine text in the panoramic point cloud image;
construct text labels to track the text determined in the panoramic point cloud image; and
support text searches for the physical environment through the text labels.

16. The non-transitory machine-readable medium of claim 15, wherein the instructions, when executed, cause the computing system to construct the text labels to include, for a given text section that includes a given text identified in the panoramic point cloud image:
an identifier for the panoramic point cloud image:
the location data for a selected point in the text section; and
the given text included in the given text section,
wherein the given text section comprises a bounding box for the given text in the panoramic point cloud image and the location data is for a selected point on or within the bounding box.

17. The non-transitory machine-readable medium of claim 15, wherein the alternate representation comprises a cube map and wherein the text labels comprise spherical theta and phi angles for coordinates of selected locations in text sections in the panoramic point cloud image that include the text.

18. The non-transitory machine-readable medium of claim 15, wherein the instructions, when executed, cause the computing system to support text searches for the physical environment through the text labels by:
identifying a text search term provided through a search query; and
providing an oriented view of the physical environment that comprises the text search term, wherein the oriented view comprises a virtual view of the physical environment oriented with respect to a location in the physical environment that comprises the text search term.

19. The non-transitory machine-readable medium of claim 18, wherein the instructions, when executed, further cause the computing system to de-skew other text sections in the oriented view that do not include the text search term.

20. The non-transitory machine-readable medium of claim 15, wherein the instructions, when executed, cause the computing system to support text searches for the physical environment through the text labels by:
determining all text that is present in a given view of the physical environment;
de-skewing text sections that include the text present in the given view of the physical environment; and
presenting the de-skewed text sections with the text present in the given view of the physical environment.
